(19) United States
(12) Patent Application Publication
(10) Pub. No.: US 2017/0222964 A1
(43) Pub. Date: Aug. 3, 2017

(54) METHODS AND SYSTEMS FOR VERIFICATION OF IN-PERSON MEETINGS

(71) Applicant: The Agreeable Company, LLC, Kansas City, MO (US)

(72) Inventors: Thomas Ian Hoffman, Kansas City, MO (US); Angela Belle Hoffman, Kansas City, MO (US)

(21) Appl. No.: 15/340,771

(22) Filed: Nov. 1, 2016

Related U.S. Application Data
(60) Provisional application No. 62/288,231, filed on Jan. 28, 2016.

(51) Int. Cl. H04L 12/58; G06Q 10/10; H04W 4/00; H04W 4/02

(52) U.S. Cl. CPC H04L 51/32; H04W 4/023; G06Q 10/1095; H04W 4/008

(57) ABSTRACT

A method includes receiving a first indication of assent to a meeting from a first user device. The meeting includes a meeting time and location. The method further includes receiving a second indication of assent to the meeting from a second user device. The method further includes determining, based on first user device geo-coordinates and second user device geo-coordinates, a no show indicating that at least one of the first user device and the second user device is not within a threshold distance of the meeting location within the threshold time of the meeting time by comparing at least one of the first user device geo-coordinates and the second user device geo-coordinates to a meeting location geo-coordinates, and determining that at least one of the first user device geo-coordinates and the second user device geo-coordinates are not within the threshold distance of the meeting location geo-coordinates.

### CROSS-REFERENCE TO RELATED APPLICATION

This application claims priority to provisional U.S. patent application No. 62/288,231, filed on Jan. 28, 2016, which is incorporated herein by reference in its entirety.

### BACKGROUND

Meetings are an important part of modern life. People meet to socialize, conduct business, exchange goods and services, plan activities, participate in leisure activities, eat together, etc. People may meet at different venues. For example, employees may meet at a company office space, friends may meet at a coffee shop, children may meet at a playground, etc. People may also meet through different mediums. For example, people may meet through websites such as online dating websites, people may have virtual meetings through telephone and/or video conferencing, people may meet in-person, etc. Accordingly, there are multitudes of reasons why meetings are scheduled, attended, and adjourned. Virtually every person will experience many different types of meetings throughout their lives with many different people.

### SUMMARY

An illustrative method according to a set of instructions stored on the memory of a computing device includes receiving, by a processor of the computing device, a first indication of assent to a meeting from a first user device. The meeting includes a meeting time and a meeting location. The method further includes receiving, by the processor, a second indication of assent to the meeting from a second user device. The method further includes determining, by the processor, first user device geo-coordinates and second device geo-coordinates at least within a threshold time of the meeting. The method further includes determining, by the processor, based on the first user device geo-coordinates and the second user device geo-coordinates, a no show indicating that at least one of the first user device and the second user device is not within a threshold distance of the meeting location within the threshold time of the meeting time. The determination of the no show includes comparing at least one of the first user device geo-coordinates and the second user device geo-coordinates to a meeting location geo-coordinates. The determination of the no show further includes determining that at least one of the first user device geo-coordinates and the second user device geo-coordinates are not within the threshold distance of the meeting location geo-coordinates.

An illustrative apparatus includes a memory, a processor operatively coupled to the memory, and a first set of instructions stored on the memory and configured to be executed by the processor. The processor is configured to receive a first indication of assent to a meeting from a first user device. The meeting includes a meeting time and a meeting location. The processor is further configured to receive a second indication of assent to the meeting from a second user device. The processor is further configured to determine, first user device geo-coordinates and second device geo-coordinates at least within a threshold time of the meeting. The processor is further configured to determine, based on the first user device geo-coordinates and the second user device geo-coordinates, a no show indicating that at least one of the first user device and the second user device is not within a threshold distance of the meeting location within the threshold time of the meeting time. The determination of the no show includes a comparison of at least one of the first user device geo-coordinates and the second user device geo-coordinates to a meeting location geo-coordinates. The determination of the no show further includes a determination based on the comparison that at least one of the first user device geo-coordinates and the second user device geo-coordinates are not within the threshold distance of the meeting location geo-coordinates.

An illustrative non-transitory computer readable medium has instructions stored thereon that, upon execution by a computing device, cause the computing device to perform operations. The instructions include instructions to receive a first indication of assent to a meeting from a first user device The meeting includes a meeting time and a meeting location. The instructions further include instructions to receive a second indication of assent to the meeting from a second user device. The instructions further include instructions to determine, a first user device geo-coordinates and a second device geo-coordinates at least within a threshold time of the meeting. The instructions further includes instructions to determine, based on the first user device geo-coordinates and the second user device geo-coordinates, a no show indicating that at least one of the first user device and the second user device is not within a threshold distance of the meeting location within the threshold time of the meeting time. The determination of the no show includes a comparison of at least one of the first user device geo-coordinates and the second user device geo-coordinates to a meeting location geo-coordinates. The determination of the no show further includes a determination based on the comparison that at least one of the first user device geo-coordinates and the second user device geo-coordinates are not within the threshold distance of the meeting location geo-coordinates.

### BRIEF DESCRIPTION OF THE DRAWINGS

Illustrative embodiments will hereafter be described with reference to the accompanying drawings.

FIG. 1 is a block diagram illustrating a first user device, a second user device, a server, and a location determination network that may be used in accordance with an illustrative embodiment.

FIG. 2 is a flow diagram illustrating a method for determining a no show based on user device locations at a certain time in accordance with an illustrative embodiment.

FIG. 3 is a flow diagram illustrating a method for proposing and accepting a meeting proposal in accordance with an illustrative embodiment.

FIG. 4 is a flow diagram illustrating a method for automatically handling a post related to a meeting or proposed meeting in accordance with an illustrative embodiment.

FIG. 5 is a figure representing a user interface illustrating a registration screen of an in-person verification meeting app that may be used in accordance with an illustrative embodiment.

FIG. 6 is a figure representing a user interface illustrating a login screen of an in-person verification meeting app that may be used in accordance with an illustrative embodiment.

FIG. 7 is a figure representing a user interface illustrating an upload photo screen of an in-person verification meeting app that may be used in accordance with an illustrative embodiment.

FIG. 8 is a figure representing a user interface illustrating a photo skip dialog screen of an in-person verification meeting app that may be used in accordance with an illustrative embodiment.

FIG. 9 is a figure representing a user interface illustrating an username selection screen of an in-person verification meeting app that may be used in accordance with an illustrative embodiment.

FIG. 10 is a figure representing a user interface illustrating a payment information input screen of an in-person verification meeting app that may be used in accordance with an illustrative embodiment.

FIG. 11 is a figure representing a user interface illustrating a messages screen of an in-person verification meeting app that may be used in accordance with an illustrative embodiment.

FIG. 12 is a figure representing a user interface illustrating a conversation message screen of a personal data sharing app that may be used in accordance with an illustrative embodiment.

FIG. 13 is a figure representing a user interface illustrating a promise/meeting creation screen of an in-person verification meeting app that may be used in accordance with an illustrative embodiment.

FIG. 14 is a figure representing a user interface illustrating a location selection screen of an in-person verification meeting app that may be used in accordance with an illustrative embodiment.

FIG. 15 is a figure representing a user interface illustrating a second location selection screen of an in-person verification meeting app that may be used in accordance with an illustrative embodiment.

FIG. 16 is a figure representing a user interface illustrating a conversation message screen with a received proposed promise/meeting message in an in-person verification meeting app that may be used in accordance with an illustrative embodiment.

FIG. 17 is a figure representing a user interface illustrating a proposed promise/meeting screen of an in-person verification meeting app that may be used in accordance with an illustrative embodiment.

FIG. 18 is a figure representing a user interface illustrating a conversation message screen with a countered proposed promise/meeting message in an in-person verification meeting app that may be used in accordance with an illustrative embodiment.

FIG. 19 is a figure representing a user interface illustrating a promise/meeting screen with a reminder dialog in an in-person verification meeting app that may be used in accordance with an illustrative embodiment.

FIG. 20 is a figure representing a user interface illustrating an active promise map screen of an in-person verification meeting app that may be used in accordance with an illustrative embodiment.

FIG. 21 is a figure representing a user interface illustrating a currently present screen of an in-person verification meeting app that may be used in accordance with an illustrative embodiment.

FIG. 22 is a figure representing a user interface illustrating a search screen of an in-person verification meeting app that may be used in accordance with an illustrative embodiment.

FIG. 23 is a figure representing a user interface illustrating a search result profile screen of an in-person verification meeting app that may be used in accordance with an illustrative embodiment.

FIG. 24 is a figure representing a user interface illustrating a settings screen of an in-person verification meeting app that may be used in accordance with an illustrative embodiment.

FIG. 25 is a figure representing a user interface illustrating a manage profile screen of an in-person verification meeting app that may be used in accordance with an illustrative embodiment.

FIG. 26 is a figure representing a user interface illustrating a profile history screen of an in-person verification meeting app that may be used in accordance with an illustrative embodiment.

### DETAILED DESCRIPTION

Described herein are illustrative embodiments for methods and systems for verification of in-person meetings. The system and methods disclosed herein allow two or more users of user devices to propose and agree (assent) to a meeting, including a meeting time and a meeting location. The systems and methods herein can determine locations of the two or more users' devices to determine if the users actually meet at the designated meeting location at the designated meeting time. The users can previously assent to the meeting location and the meeting time, as well as other details of the meeting. Such details may include a subject, such as a title of an item to be exchanged during the meeting. The meeting time may include a date of the meeting as well as a threshold of time from the meeting time within which a user will still be considered present at the meeting. If a user does not arrive at the meeting location within the threshold (or grace period) time from the meeting time, the system may consider that user a no show. Similarly, the meeting location may include a threshold location from the meeting location within which the user will still be considered present at the meeting. The meeting details may also include cancelation terms. For example, the users may agree that a meeting may be canceled up until two hours before the scheduled meeting time. If a meeting is canceled within the cancelation time, the system may consider that the user who canceled the meeting to be a no show. When the system determines a no show, the user who did not show may be assessed a penalty or monetary charge/fine. This serves as an incentive for each party to show up at the time and location assented to by each user. In some embodiments, some or all of the monetary charge assessed to the no show user may be credited to the user that did show. If both users do not show, no charges or credits may be assessed. In an alternative embodiment, if two users do not show they may both be assessed a monetary charge or fine.

Advantageously, the systems and methods disclosed herein may be used in conjunction with marketplaces, such as online marketplaces (e.g., Craigslist™, OfferUp™, Facebook™ swap groups, Varage Sale™) to ensure that two parties that wish to exchange goods, currency, services, etc. both show up to a meeting to make the exchange. For example, a user may publish a posting to sell a recliner on Craigslist™. If a second user messages the first user and is interested in buying the recliner, the two users may set a time and location to meet so that the second user can inspect and possibly buy the recliner. However, if the second user does not show up at the designated meeting time and location, the first user may have wasted much time and effort in setting aside time to meet the second user. Even worse, the first user may have gone to the trouble of transporting the recliner to the meeting in hopes of exchanging the recliner for money with the second user. Advantageously, the methods and systems disclosed herein offer incentives for both the first and the second users to show up to a meeting that both have previously assented to. If one of the users does not show, the systems and methods disclosed herein can automatically determine that one of the users was a no show and cause money to be paid by the non-showing user to the user that did show up to the meeting. This system can result in more users showing up to agreed upon meetings, leading to less time and effort wasted by users of such marketplaces.

The systems and methods disclosed herein may also be used in other implementations. For example, such a system may be helpful with users including, but not limited to, service professionals. For example, if a user is waiting at home for a plumber to fix a sink, use of the systems and methods disclosed herein may help incentivize the plumber to show up at an agreed upon time and incentivize a resident to be home at the agreed upon time so that the plumber can access the property and perform the necessary service. In another example, the systems and methods disclosed herein may be used to incentivize a restaurants and their customers to honor a reservation time. In another example, the systems and methods disclosed herein may be used to incentivize doctors and patients to honor appointment times. In another example, a customer of a phone store or other type of consumer goods store may have an appointment for service or purchasing of a device. In another example, the systems and methods herein may be used for delivery systems such as when a receiver of a package needs to sign for a package to ensure that the driver and receiver meet at the same location and time. Such systems and methods as disclosed herein may also be advantageously applied to such in-store appointments to incentivize customers as well as businesses to honor mutually assented to meetings.

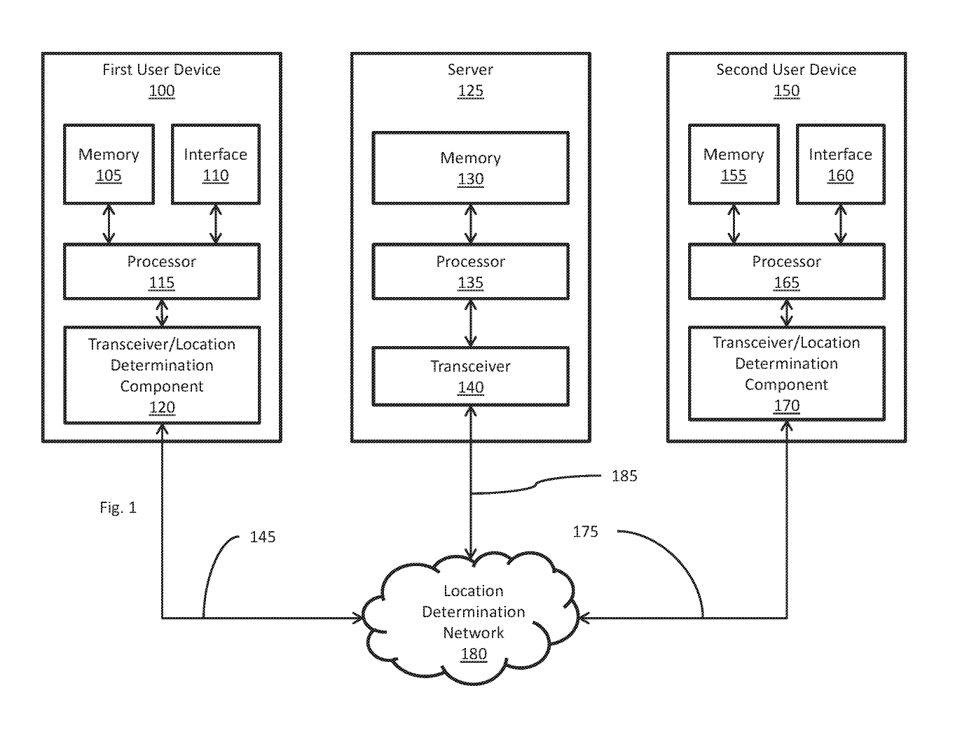

FIG. 1 is a block diagram illustrating a first user device 100, a second user device 150, a server 125, and a location determination network 180 that may be used in accordance with an illustrative embodiment. In alternative embodiments, fewer, additional, and/or different components may be included in the system. The first user device 100 includes a processor 115 that is coupled to a memory 105. The processor 115 can store and recall data and applications in the memory 105. The processor 115 can execute sets of instructions stored on the memory. In one example, a set of instructions may be a mobile application (app). The memory 105 may store more than one app. Throughout the present application, if an app is referred to, it can mean a set of instructions stored on a memory that can be executed by a processor. In various embodiments, an app may be executed through a web browser; an application stored on a computing device such as a mobile phone, tablet, or laptop computer; etc. For example, an in-person verification meeting app as disclosed herein may be stored in the memory 105. Here, the processor 115 may also display objects, applications, data, etc. on an interface 110. A user may also interact with the first user device through the interface 110.

The processor 115 is also coupled to a transceiver/location determination component 120. The transceiver/location determination component 120 includes hardware that allows the processor 115, using software stored on the memory 105, to determine a location of the first user device 100. In an alternative embodiment, the processor 115 and the transceiver/location determination component 120 work in conjunction with a server 125 and/or location determination network 180 to determine a location of the first user device 100. The transceiver/location determination component 120, location determination network 180, and/or server 125 may be configured to locate the first user device using various types of location determining technology, such as global positioning system (GPS), near field communication (NFC) devices, Wi-Fi devices, radio frequency identification (RFID) devices, iBeacon™ devices, and/or the like to determine the location of the first user device 100. GPS systems use satellites as part of the location determination network 180 to determine a precise location of a user device. NFC, RFID, iBeacon™, Bluetooth, and Wi-Fi devices may also be used to determine the location of the first user device. For example, such devices may be a part of the location determination network 180. If the user device 100, for example, communicates with one of these devices, a communication may be made with the server with the server 125 through connections 145 and 185. The server may have stored upon it the specific locations of various NFC, RFID, iBeacon™, Bluetooth, and Wi-Fi devices. Thus, when the first user device 100 communicates with such a device, the server 125 can identify the location of the first user device 100. In some embodiments, the systems and methods disclosed herein may use multiple types of location determination devices and services. Other types of location determination services and devices may also be used. For example, cellular or other wireless network triangulations may be used. Proximity sensors may be used. Codes that are only displayed at particular locations may be entered into or scanned by the first user device 100. Thus, the particular code when entered or scanned can be communicated to the server 125 to identify the location of the first user device 100. Other ways of determining location of the user devices are also contemplated.

The server 125 includes a processor 135 that is coupled to a memory 130. The processor 135 can store and recall data and applications in the memory 130. The processor 135 is also coupled to a transceiver 140. With this configuration, the processor 135, and subsequently the server 125, can communicate with other devices, such as the first user device 100 through the connection 145, the location determination network devices 180, and the connection 185. The server can also communicate with a second user device 150 through a connection 175, the location determination network devices 180, and the connection 185. The memory 130 may be used to store various user data, such as user profile data. The memory may also store the location of various location determination network 180 devices, such that the processer 135 can determine the location of user devices based on communications with the various location determination network 180 devices and/or the user devices 100 and 150 themselves. The memory 130 may also be used to record the locations that the user devices 100 and 150 are determined to be at, as well as the times present and other meeting related data.

The second user device 150 is similar to the first user device 100 and has at least all the components and functionalities of the first user device 100 as described above. The second user device 150 includes a processor 165 that is coupled to a memory 155. The processor 165 can store and recall data and applications in the memory 155. The processor 165 can execute sets of instructions stored on the memory. In one example, a set of instructions may be a web browser that displays and/or executes a webpage. The processor 165 may also display objects, applications (apps), data, etc. on an interface 160. The processor 165 is also coupled to a transceiver/location determination component 170. With this configuration, the processor 165, and subsequently the second user device 150, can communicate with other devices, such as the server 125 through the connections 175 and 185 as well as the first user device 100 through the connections 145 and 175. For example, the first user device 100 and the second user device 150 may use parts of the location determination network 180, such as the internet, cellular networks, data networks, Wi-Fi networks, etc., to communicate with each other. Such communications may include meeting requests, meeting counter requests, assents to meeting details, and messages related to meetings or other topics. Such communications are further discussed and disclosed herein.

In an illustrative embodiment, the first user device 100 and the second user device 150 may be smart phones. In other embodiments, other devices may be used, such as location service enabled smart watches or other wearables, tablets, laptops, etc. The devices shown in FIG. 1 are merely one physical system on which the disclosed embodiments may be executed. Other configurations of devices with location determining capabilities may exist to practice the disclosed embodiments. Further, configurations of additional or fewer devices than the ones shown in FIG. 1 may exist to practice the disclosed embodiments. Additionally, the devices shown in FIG. 1 may be combined to allow for fewer devices or separated where more than the three devices shown exist in a system.

The devices shown in the illustrative embodiment may be utilized in various ways. For example, the connections 145, 175, and 185 as well as the location determination network 180 may be varied. The connections 145, 175, and 185 as well as the location determination network 180 may include some hard wired connections. A hard wired connection may involve connecting the devices through a USB (universal serial bus) port, serial port, parallel port, or other type of wired connection that can facilitate the transfer of data and information between a processor of a device and a second processor of a second device, such as between the components of the location determination network 180 and the server 125. In other embodiments, the connections 145, 175, and 185 as well as the location determination network 180 may include wireless connections and associated components. Such connections and components may take the form of any sort of wireless connection, including but not limited to Bluetooth connectivity, Wi-Fi connectivity, or another wireless protocol. Other possible modes of wireless communication may include near-field communications (NFC), such as passive radio-frequency identification (RFID) and active (RFID) technologies. RFID and similar near-field communications (NFC) may allow the various devices to communicate in short range when they are placed proximate to one another. In an embodiment using near field communication, two devices may have to physically (or very nearly) come into contact, and one or both of the devices may sense various data such as acceleration, position, orientation, velocity, change in velocity, IP address, and other sensor data. The system can then use the various sensor data to confirm a transmission of data over the internet between the two devices. In yet another embodiment, the devices may connect through an internet (or other network) connection. That is, the connections 145, 175, and 185 as well as the location determination network 180 may represent several different computing devices and network components that allow the various devices to communicate through the internet and/or other networks, either through a hard-wired or wireless connection. The connections 145, 175, and 185 as well as the location determination network 180 may also be a combination of several modes of connection.

To operate different embodiments of the system or programs disclosed herein, the various devices may communicate in different ways. For example, the first and second user devices 100 and 150 may download a software application, such as an app, from the internet. In another embodiment, the first and second user devices 100 and 150 may access an interface with the functionalities disclosed herein through a browser or virtual machine. Such software applications may allow the various devices in FIG. 1 to perform some or all of the processes, methods, and functions described herein. Additionally, the embodiments disclosed herein are not limited to being performed only on the disclosed devices in FIG. 1. Many various combinations of computing devices may execute the methods and systems disclosed herein. Examples of such computing devices may include desktop computers, cloud servers, smart phones, personal computers, servers, laptop computers, tablets, blackberries, RFID enabled devices, wearable electronic devices, or any combinations of such devices or similar devices.

In one embodiment, a download of an in-person meeting verification app to the first and second user devices 100 and 150 involves the processors 115 and 165 receiving data from the server 125. The processors 115 and 165 may store the app in the memories 105 and 155. The processors 115 and 165 can then execute the app at any time, including at a time specified by first and second users through the interfaces 110 and 160. In another embodiment, some aspects of a program or app may not be downloaded. For example, the program or app may be an application that accesses additional data or resources located in the server 125 or the user devices 100 and 150 themselves. For example, the app may utilize transceiver/location determination components 120 and 170 such as GPS functionality (both hardware and software) that is already installed and a part of the first and second user devices 100 and 150. In another example, the app may be an internet-based application, where the app is executed by a web browser and stored almost exclusively in the server 125, such as a browser run on the second user device 150.

In yet another embodiment, once downloaded to the first and second user devices 100 and 150, the program or app may operate in part without communication with the server 125. In this embodiment, the first and second user devices 100 and 150 may access or communicate with the server 125 only when acquiring the program or sharing data with the server 125. In other embodiments, a constant or intermittent connection may exist between the server 125 and the first and second user devices 100 and 150. Where an intermittent connection exists, the first and second user devices 100 and 150 may only need to communicate data to or receive data from the server 125 occasionally.

The configuration of the server 125, the first user device 100, the second user device 150, and the location determination network 180 is merely one physical system on which the disclosed embodiments may be executed. Other configurations of the devices shown may exist to practice the disclosed embodiments. Further, configurations of additional or fewer devices than the ones shown in FIG. 1 may exist to practice the disclosed embodiments. Additionally, the devices shown in FIG. 1 may be combined to allow for fewer devices or separated where more than the two devices shown exist in a system.

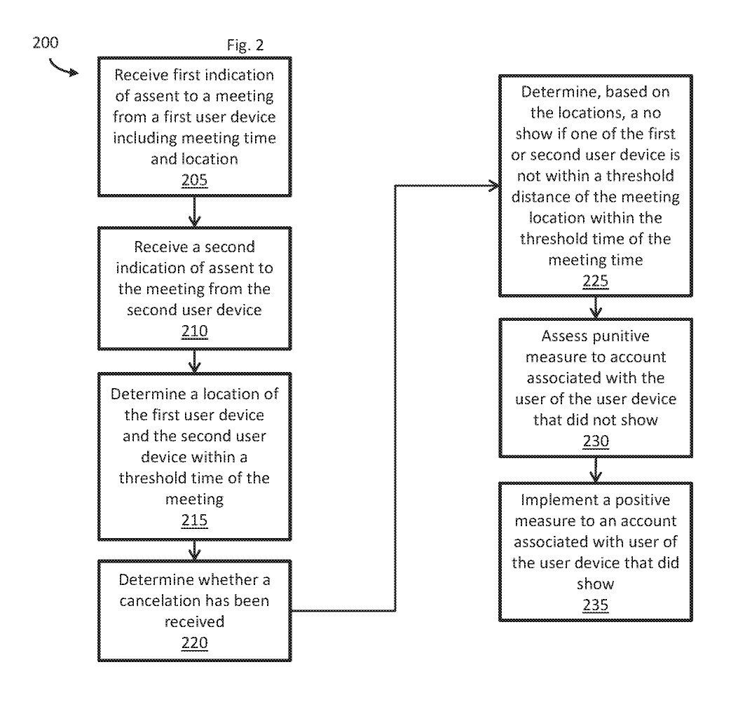

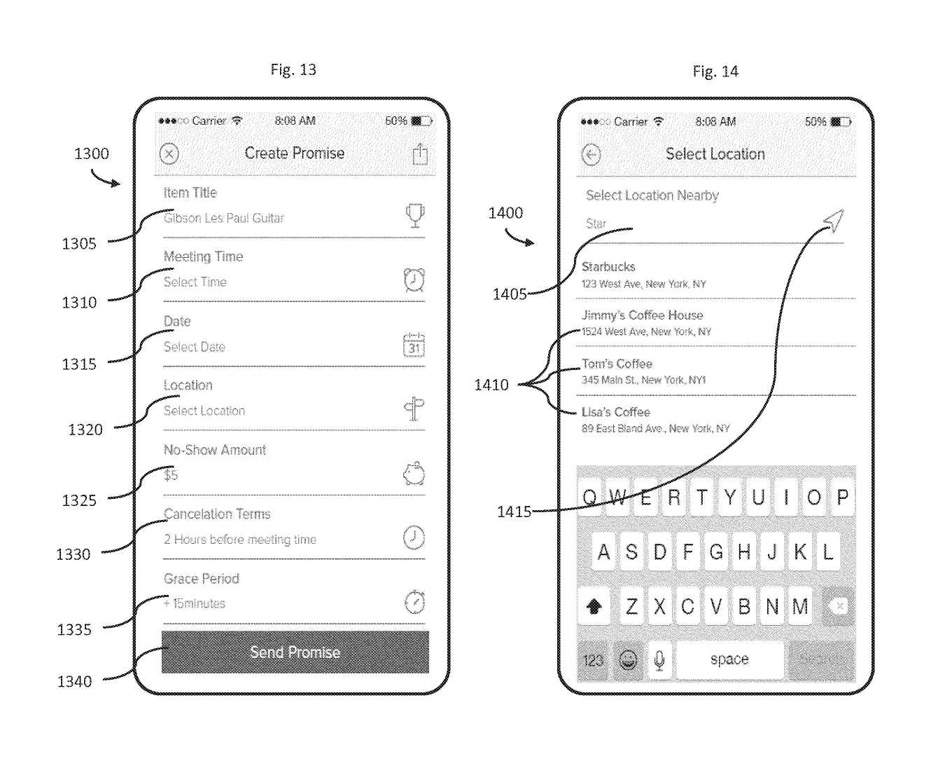

FIG. 2 is a flow diagram illustrating a method 200 for determining a no show based on user device locations at a certain time in accordance with an illustrative embodiment. In alternative embodiments, fewer, additional, and/or different operations may be performed. Also, the use of a flow diagram is not meant to be limiting with respect to the order of operations performed. In an operation 205, first indication of assent to a meeting from a first user device is received. In other words, the first user device receives an indication that a first user agrees to the details of the meeting, which can then be sent from the first user device to a server. For example, the first user device 100 and the server 125 as described above with respect to FIG. 1 may be used in this manner. This may occur by the first user device receiving an indication of agreement to predefined or preset details of a meeting, or through receiving indications of user-defined details of the meeting (e.g., as described below with respect to FIG. 13). Once the first user device receives the indication of agreement to and/or receives the indications of the details of the meeting, the first user device sends the meeting proposal/request to a second user device. By sending the meeting request/proposal, the first user device indicates an assent to the details of the meeting as included in the meeting request/proposal.

The first user device includes at least one of hardware and software configured to determine a location of the first user device. For example, the first user device may be and function similarly to the first user device 100 as described above with respect to FIG. 1. As described above, such hardware and or software may include location determination components such as a GPS locator, NFC device configured to communicate with other NFC devices in order to determine the location of a user device, wireless transponder and/or transceiver devices configured to communicate wirelessly with networks or devices such that the communication indicates at least in part the location of the user device. The meeting itself includes at least a meeting time and a meeting location for the users to assent to. Other details about the meeting may also be included in a meeting request/proposal. In one embodiment, the meeting time is a specific time, and the threshold time is an amount of time, such that the no show is determined when the first user device and the second user device are not within the threshold distance of the meeting location at any time within the amount of time before the specific time to the amount of time after the specific time. The determination of the no show is further discussed below with respect to operation 225. In an alternative embodiment, a meeting time may be a range of time lasting from a first time to a second time. For example, the meeting time may be any time between 2 and 4 PM. A ranged meeting time such as this may or may not have a grace period (threshold time) outside of the meeting time in which the user device will still be counted as present for the meeting. For example, with no grace period, the threshold time (grace period) for the meeting is zero minutes, such that the no show is determined when one of the first user device and the second user device are not within the threshold distance of the meeting location at any of the range of time.

In an operation 210, a second indication of assent to the meeting from a second user device is received. The second user device, like the first user device, includes at least one of hardware and software configured to determine a location of the second user device, such as the location determination components discussed above. For example, the second device may be and function similarly to the second user device 150 as described above with respect to FIG. 1. When the second user device receives an indication of assent to the meeting through an interface of the second user device, the second user device sends the assent/agreement to the details of the meeting proposal/request, such as the meeting time and the meeting location to a server, for example. Assent received from both the first and second user devices to the details of the meeting establishes the meeting for the first user device and the second user device. Other details of the meeting may be included in addition to meeting time and meeting location, and are discussed below at length (e.g., with respect to FIG. 13 below).

In an operation 215, a first user device location and a second device location are determined by the system at least within a threshold time of the meeting. For example, the locations of the first and second devices may be determined from five minutes before a meeting time until five minutes after the meeting. Such a threshold time may be agreed to as part of the meeting details, or it may be a predefined threshold amount. In an alternative embodiment, the threshold time may be significantly larger than a grace period threshold agreed to, as indicated by the user devices. In other words, the times that the locations of the first and second user devices are determined may not correlate to the times that do not constitute a no show of a user. That is, a user device's location may be determined even before a meeting time and a threshold of time within the meeting time that a user device would be considered present for the meeting. In a specific example, the system may begin determining user device locations two hours before a meeting time, but the user device may not be counted as present for the meeting until three minutes before the meeting starts. In another embodiment, the system may track the user device locations whenever the in-person meeting verification app is active, regardless of when, if any, meeting times are. In another embodiment, the system may track the user device locations at all times. However, for purposes of determining whether a user is present for a particular meeting, the system determines the first and second user device locations at least within a threshold time of the meeting.

In an illustrative embodiment, the system determines the device locations by utilizing at least transceivers/location determination components of the first and second user devices, as well as a location determination network. For example, devices, networks, and servers as shown in FIG. 1 and described above may be used. In one example, the first and second user devices are equipped with GPS location determination components. The GPS location determination components in cooperation with a processor of a user device can determine the geo-coordinates of a user. The geo-coordinates of a user device may be determined using components of a location determination network, such as satellites. Upon determining the geo-coordinates of the first user device by the first user device, the first user device sends its geo-coordinates to the server through network components, possibly including aspects of the location determination network, but not necessarily. For example, if GPS location is utilized, the first user device may send its location over a cellular data network rather than a satellite network used to determine location. However, if a cellular telephone or data network is used to triangulate or otherwise determine a user device location (geo-coordinates), the geo-coordinates may be sent over that very same cellular telephone or data network. Similarly, the second user device also determines its location using a location determination component such as a GPS locator. In other words, the first user device geo-coordinates can be determined by a GPS locator in the first user device and the first user device geo-coordinates are received by the processor of the server over a communications network. In other embodiments, the server may actually determine the geo-coordinates, instead of the geo-coordinates being determined by the first and second user devices and then being sent to the server. For example, where a cellular network is used, the location of the user devices may be determined by the server based on other transmissions to and/or from the user devices that do not explicitly include the geo-coordinates. For example, the geo-coordinates (location) of a user device may be determined by triangulation in a cellular network, the geo-coordinates may be inferred by the server or a user device on the basis of a user device connection to a known Wi-Fi network, or the geo-coordinates may be inferred on the basis of a user device communication with a Wi-Fi device, NFC device, iBeacon™ device, Bluetooth device, or the like. For example, the first user device geo-coordinates can be determined by a first NFC device in the first user device that is configured to communicate with other NFC devices, and the first user device geo-coordinates are inferred by the processor of the server based on a first communication between the first NFC device and one of the other NFC devices based on an indication of the first communication that is received by the processor of the server over a communications network. In another example, the first user device geo-coordinates are determined by a first wireless transponder device of the first user device that is configured to communicate wirelessly with a plurality of network devices, and the first user device geo-coordinates are inferred by the processor of the server based on a first communication between the first wireless transponder device and one of the plurality of network devices based on an indication of the first communication that is received by the processor of the server over a communications network.

In an operation 220, the system determines if a valid cancelation has been received from either of the user devices. A valid cancelation is one that is received before a cancelation threshold of time from the meeting time. The cancelation time can be indicated by the first user device, for example, as part of the meeting request/proposal. In order to do so, an indication of the cancelation time is received from the first user device. the cancelation time includes an amount of time before the meeting time within which an indication of revoked assent to the meeting must be received from the first user device or the second user device to prevent a determination of a no show. In other words, the cancelation time is the amount of time before the meeting time that a user must cancel the meeting to avoid being considered a no show by the system. If a valid cancelation is received, the meeting no longer will be enforced and neither user can be determined to be a no show. One or both of the user devices may also be sent a notification or alert indicating that the meeting has been canceled.

In an operation 225, based on the first user device location and the second user device location, a no show is determined indicating that at least one of the first user device and the second user device are not within a threshold distance of the meeting location within the threshold time of the meeting time. The no show indicates that the first user device is not within the threshold distance of the meeting location within the threshold time of the meeting time. In other words, the system determines a no show if one of the first or second user devices is not close enough to the meeting location within the threshold amount of time from the meeting time. For example, if the threshold time is five minutes before and after the meeting and the threshold distance is fifty (50) feet, a no show will be determined if one of the first or second user devices is not within 50 feet of the meeting location within five minutes of the meeting time. In another embodiment, the grace period or threshold time may only be after the meeting time. That is, for example, a user device will be counted as present only if it is within the threshold distance at the meeting time and the threshold of time after the meeting time. For example if the meeting time is 5 PM and the grace period/threshold is ten minutes, then a user device is considered present if it is within the threshold distance of the meeting location at any time between 5 PM and 5:10 PM.

In particular, the determination of a no show is made based on the location or geo-coordinates of the first user device and the second user device. As discussed above with respect to the operation 215, the geo-coordinates of the first and second user devices may be determined in various ways, including by the user devices and sent to the server, or by the server itself. The no show can be determined based on these geo-coordinates at specific times. In one embodiment, the system compares the geo-coordinates of the user devices to the meeting location that the system has received an assent to from each of the first and second user devices. In comparing the geo-coordinates to the meeting location, the system determines a distance each of the first and second user devices are from geo-coordinates associated with the meeting location. If each of the geo-coordinates of the first and second user devices are within the threshold distance of the geo-coordinates of the meeting location at the meeting time (or within a threshold time of the meeting time as disclosed herein), then the system determines that both the first user device and the second user device are present for the meeting. If the system determines that one of the geo-coordinates of the first user device or the geo-coordinates of the second user device are not within the threshold distance of the geo-coordinates of the meeting location at the meeting time (or within a threshold time of the meeting time as disclosed herein), then the system determines the no show for the first user device or the second user device, respectively.

In another illustrative embodiment, the system may use the geo-coordinates of the first user device and the geo-coordinates of the second user device in relation to each other. In this embodiment, the users may agree to a meeting location or may not agree to a meeting location as a detail of the meeting. Instead of comparing the user devices' geo-coordinates to a meeting location geo-coordinates, the geo-coordinates of the first and second devices are compared to each other. If the geo-coordinates of the first user device are within a threshold distance (e.g., 10 feet) of the geo-coordinates of the second user device at the meeting time (or within a threshold time of the meeting time as disclosed herein), then the system determines that the meeting has taken place. If the geo-coordinates of the first user device are not within a threshold distance (e.g., 10 feet) of the geo-coordinates of the second user device at the meeting time (or within a threshold time of the meeting time as disclosed herein), the system determines a no show of at least one of the first and second user devices. In one example, the geo-coordinates of the meeting location may be used to determine which of the first and second user devices is a no show. For example, if the user devices never come within the threshold distance of each other, the system then compares each of the user devices' geo-coordinates to the geo-coordinates of the meeting location. If one of the geo-coordinates of the user devices is not within a second threshold distance of the geo-coordinates of the meeting location at the meeting time (or within a threshold time of the meeting time as disclosed herein), then a no show may be determined for the user device that was not close to the meeting location at or close to the meeting time. If the geo-coordinates of the two user devices are close enough to each other at or close to the meeting time, the system may consider a meeting to have happened and may or may not compare the geo-coordinates of the user devices to the meeting location.

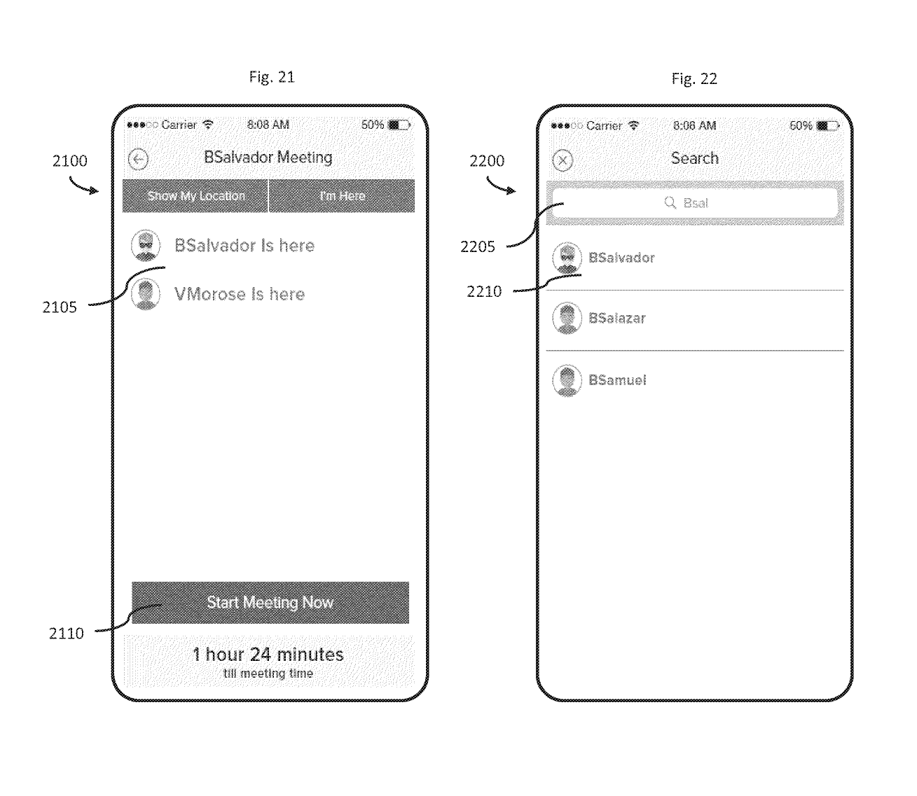

In one illustrative embodiment, the determination of the no show is automatically made without regard to any inputs from a first user into a user interface of the first user device and further without regard to any inputs from a second user into a user interface of the second user device. In other words, the users do not make any input into the user devices to indicate that they are present at the meeting or that the meeting is being held. The system can automatically determine the location of a user device at particular times in order to determine whether the user is present for a meeting. In other embodiments, the determination of a no show may be based on an input or lack thereof from a user. That is, a user may input that they are present for the meeting in order for the system to determine the location and time for the user device to avoid a no show determination. For example, the user may select a button on an interface of their user device to make such an input. Button 2010 of FIG. 20 or 2110 of FIG. 21 as described below may, for example, suffice as inputs to indicate the presence of a user for a meeting.

In another illustrative embodiment, the no show is determined based on a determination that only one, but not both, of the first user device and the second user device are not within the threshold distance of the meeting location within the threshold time of the meeting time. In other words, if both of the first user device and second user device do not show, the system does not determine a no show. In an alternative embodiment, the system may still determine a no show if both the first and second user devices do not show for the meeting. In such an embodiment, accounts for both users may be assessed a monetary charge.

In an operation 230, the system assesses, based on the determination of a no show by the first user device for example, a punitive measure associated with the first user device. For example, the system may assess a monetary charge to an account associated with the first device. In other words, whatever user does not show for the meeting is charged money. In other embodiments, the system may enforce other punitive measures or negative consequences on a user who is a no show. For example, the system may deduct some sort of rewards points, discounts, or promotional rates that the user could have otherwise used. In another embodiment, the system may prevent use of the system or certain functionalities of the system based on a no show of a user. For example, if a user is a no show one time (or some other predetermined amount of times), the system may prevent the user from accepting meeting proposals/requests for one week. In another example, the system may adjust the consequence based on how many prior no shows are associated with a user. For example, a user who habitually has no shows may be assessed higher penalties for a no show than a user who has few or zero prior no shows. In an alternative embodiment, the system may (instead of applying a consequence for a no show) instead offer an incentive for a successful meeting (both users present for the meeting) in the form of expanded functionality, rewards, discounts, monetary credits, etc.

In an operation 235, the system implements, based on the determination of the no show, a positive measure to an account associated with the user device that did show. For example, if the first user device is a no show, the system may implement a credit of money to an account, such as a bank account of the second user. Further, some or all of the money credited to the account of the second user may be assessed as a charge to the first user. That is, some or all of the money may be transferred from the first user's account to the second user's account because of the no show of the first user. Such a transfer dis-incentivizes no shows. The accounts that are assessed charges or credited a monetary amount may be bank, credit card, Paypal™, or any other kind of accounts. Information related to the accounts may be input by a user before a meeting is set up so that the charges and credits can be done automatically (without user interaction) when a no show is determined. For example, entry of such information is further discussed below with respect to FIG. 10.

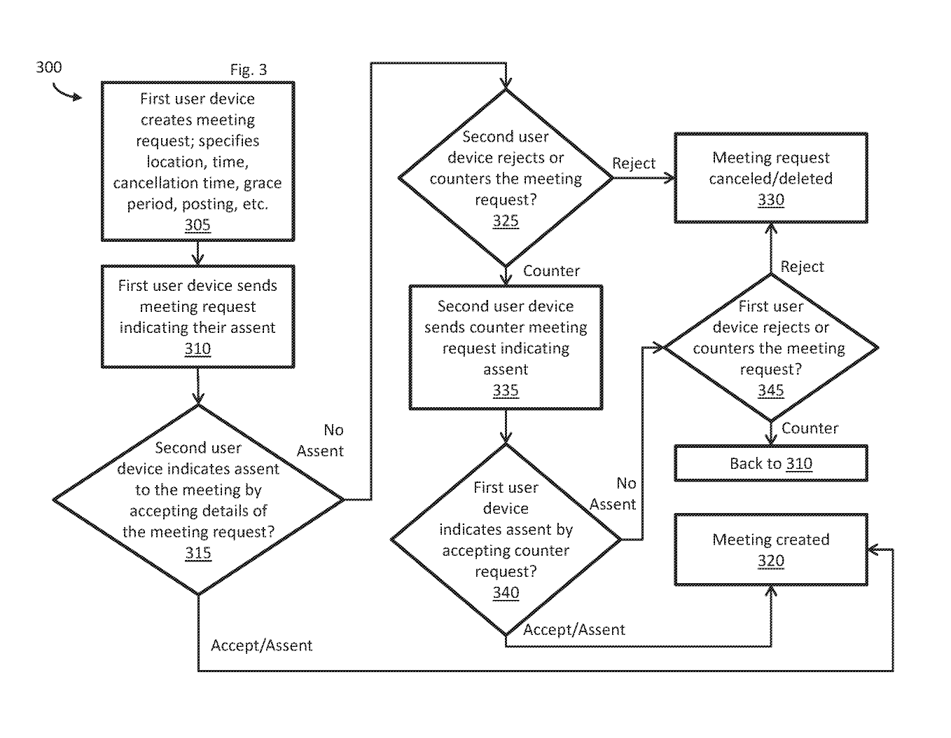

FIG. 3 is a flow diagram illustrating a method 300 for proposing and accepting a meeting proposal in accordance with an illustrative embodiment. In alternative embodiments, fewer, additional, and/or different operations may be performed. Also, the use of a flow diagram is not meant to be limiting with respect to the order of operations performed. In an operation 305, interactions with a first user device causes creation of a meeting request and specifies the location, time, cancelation time, and grace period associated with the meeting. The meeting can be related to a sale of a good or provision of a service. In particular, interactions with the user device may cause the meeting request/proposal to be associated the with the good or service itself. For example, the sale of the good or the provision of the service can be related to an online posting. In an illustrative embodiment, the in-person meeting verification app as disclosed herein can be used more efficiently to effect such an online posting. In a first example, information from a meeting request may be used to generate and publish an online posting. For example, if a user device creates a meeting request for an item, the app may facilitate creating a post for one or more online marketplaces based on the item as well. In a second example, the app may facilitate creating a post for an item on which a meeting request/proposal may later be based. In a third example, the system may utilize information in a post published without assistance from the app in order to populate information into the meeting request/proposal.

In an operation 310, the first user device sends the meeting request/proposal to the second user device. In sending the meeting request/proposal, the first user device also indicates an assent to the details of the meeting in the request.

In an operation 315, the system determines whether the second user device indicates assent to the details of the meeting request/proposal from the first user device by an indication of acceptance of the details. If the details are accepted/assented to, the meeting is created in the system at an operation 320. When a meeting is created, the user devices who have assented to it (here the first and second users devices) are bound to the details of the meeting.

If there is not assent to the details by the second user device at the operation 315, the second user device can reject the meeting request/proposal or counter the meeting request/proposal with a meeting request/proposal that has different details in an operation 325. If the meeting request/proposal is outright rejected by the second user device, the meeting request is canceled or deleted at an operation 330. The user devices may be able to display canceled meeting requests/proposals unless they have been deleted.

If the meeting request/proposal from the first user device is countered by the second user at the operation 325, the second user device receives changes the details and then sends the counter meeting request/proposal to the first user device in an operation 335. By sending the changed counter meeting request/proposal, the second user device indicates assent to the updated/changed details of the meeting request/proposal.

In an operation 340, the first user device receives the counter meeting request/proposal, and the first user device may indicate assent to the updated details by accepting the counter request/proposal. If the first user device does accept/assent to the new details, the meeting with the updated details is created at the operation 320. If the first user device does not assent to the new details, the first user device can indicate a rejection or counter the counter meeting request/proposal sent from the second user device in an operation 345. If the first user device rejects the counter from the second user, the meeting request is canceled or deleted in the operation 330. If the first user device counters the meeting request/proposal from the second user device, the process returns to the operation 310 where the first user s device ends the new counter proposal to the second user device. Ultimately, both user devices should assent to the specific details of a meeting request before a meeting is created, and failure of both user devices to assent causes continuing counter proposals or a meeting request getting canceled and/or deleted.

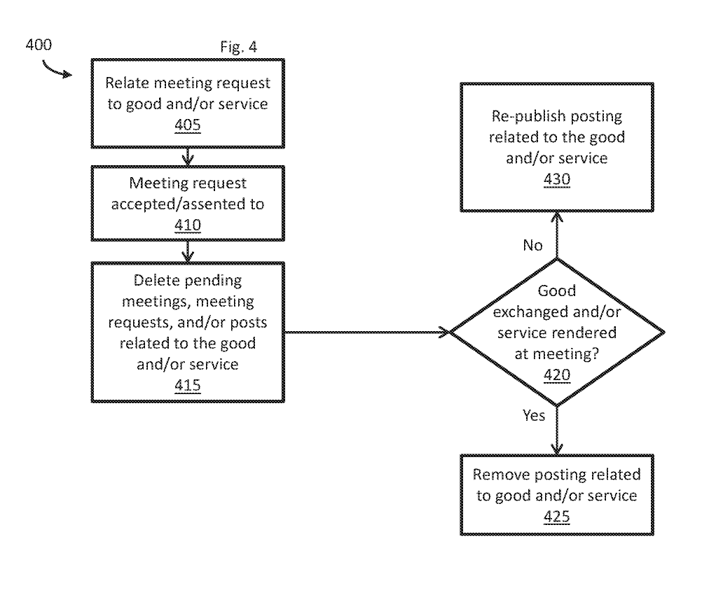

FIG. 4 is a flow diagram illustrating a method 400 for automatically handling a post related to a meeting or proposed meeting in accordance with an illustrative embodiment. In alternative embodiments, fewer, additional, and/or different operations may be performed. Also, the use of a flow diagram is not meant to be limiting with respect to the order of operations performed. In an operation 405, the meeting request is related to a good and/or service. For example, a meeting request may be related to a meeting to inspect and potentially buy an automobile. The meeting request may also be related to a posting in an online marketplace that lists the automobile for sale. In an operation 410, the meeting request is accepted/assented to by both user devices related to the meeting for the automobile.

In an operation 415, the system automatically deletes any pending meetings, meeting requests, and/or other posts published in online marketplaces, forums, etc. that are related to the good or service that is the subject of an accepted meeting. In one embodiment, the sale of the good or the provision of the service can be related to a plurality of meeting requests received or initiated by the first user device. For example, if a meeting has been accepted by a first and second user device related to the first user's automobile, the system may deleted pending meeting requests/proposals related to the automobile with a third user device. In other words, a plurality of meeting requests can be canceled or revoked based on the second indication of assent to the meeting from the second user device. In another example, the system may delete any online posts from any online marketplace, forum, etc. which are related to the automobile in response to a meeting being accepted/assented to by the first and second user devices.

In an operation 420, the system may determine whether the good was exchanged and/or the service was rendered (whatever was the subject of the meeting) at the meeting. In other words, the system receives an indication from the first user device or the second user device that the sale of the good or the provision of the service is completed at the meeting. The indication may be input through a user interface of one or both of the first and second user devices.

In an operation 430, if the good was not exchanged or the service was not rendered at the meeting, the system re-publishes the online posting in a forum in which the online posting was previously published. The system could also publish the online posting in forums or marketplaces where the posting was not previously published. In an operation 425, if the good was exchanged or the service was rendered at the meeting, the system removes the online posting from a forum in which the online posting is published if that was not already done in the operation 415. In another illustrative embodiment, if the good was exchanged and/or the service rendered, the in-person meeting verification app may further facilitate the transaction. For example, if the first and second users have entered financial account (e.g., bank, credit card, Paypal™) information into their respective user devices, the system may process a transfer of funds for the good or service as agreed to by the parties. The parties may agree to a price for the good using a process similar to that of FIG. 3 where each user device has to indicate an assent to the price before a transaction is processed. In another illustrative embodiment, one or both of the users' accounts may be assessed a fee for utilizing the in-person meeting verification app.

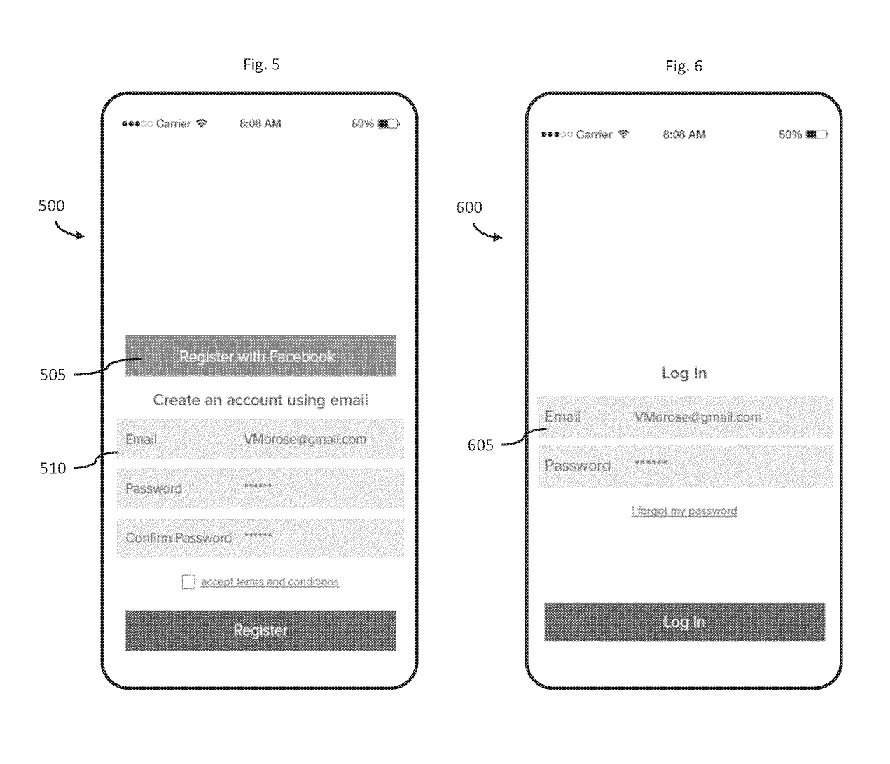

FIG. 5 is a figure representing a user interface illustrating a registration screen 500 of an in-person verification meeting app that may be used in accordance with an illustrative embodiment. The registration screen 500 includes a register with Facebook™ button 505 and a create account using fields 510. The button 505 may link to an outside website to verify login credentials. In an alternative embodiment, the button 505 may lead to a login screen 600 as shown in FIG. 6, and the user can just enter their third party (such as Facebook™) credentials to log in to the app. The app in this embodiment can verify the credentials entered related to the third party. The fields 510 can be used to register a new account.

FIG. 6 is a figure representing a user interface illustrating a login screen 600 of an in-person verification meeting app that may be used in accordance with an illustrative embodiment. The fields 605 can be used to log in to the app. The login credentials used may have been established using the registration screen 500 like that shown in FIG. 5.

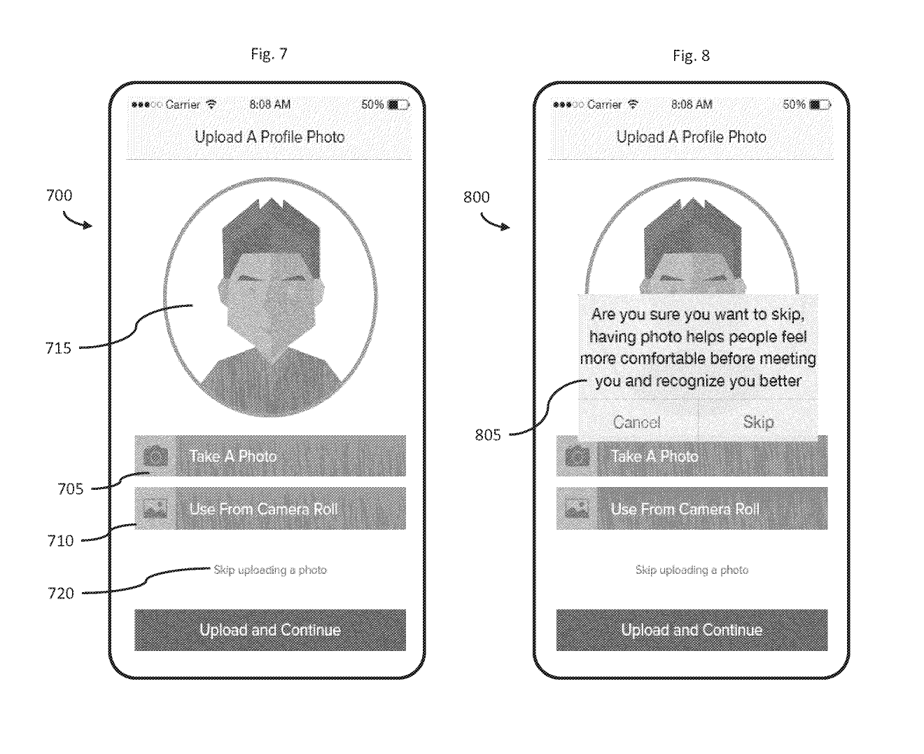

FIG. 7 is a figure representing a user interface illustrating an upload photo screen 700 of an in-person verification meeting app that may be used in accordance with an illustrative embodiment. The upload photo screen 700 includes a button 705, which can be pushed to take a photo of the user using a camera to be used as a profile photo. A button 710 can be pushed to access photos already stored on a user device to use as a profile photo. A button 720 can be pressed to skip uploading a profile photo. Photo 715 shows a currently selected profile photo.

FIG. 8 is a figure representing a user interface illustrating a photo skip dialog screen 800 of an in-person verification meeting app that may be used in accordance with an illustrative embodiment. A dialog 805 indicates to a user that a profile photo is desirable and provides the option to cancel progressing without a photo or to skip selecting a profile photo. The dialog 805 may appear, for example, if the button 720 of FIG. 7 is pressed.

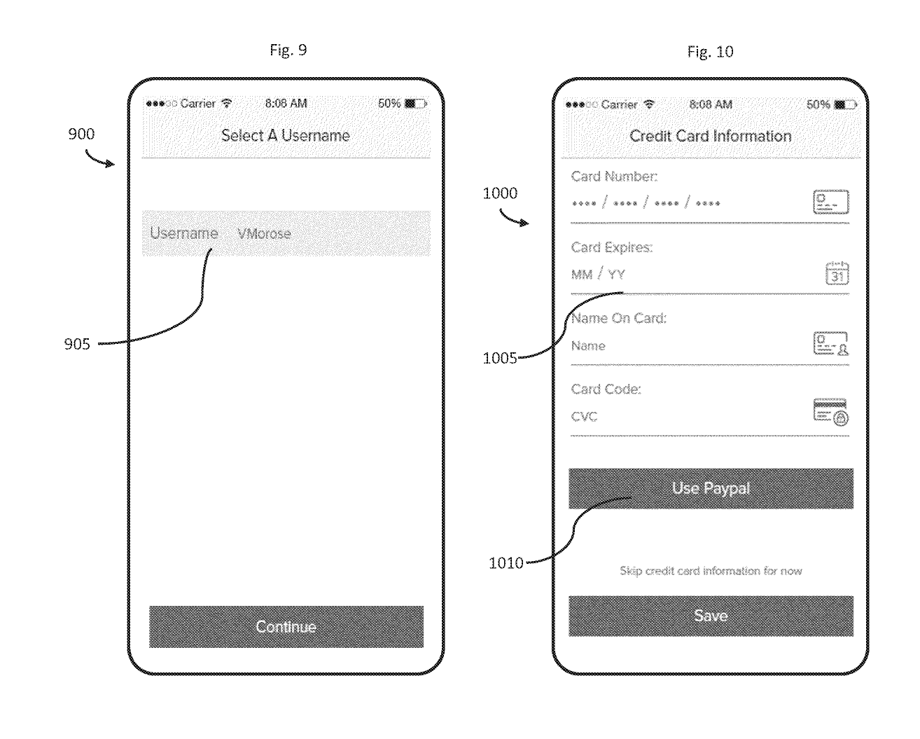

FIG. 9 is a figure representing a user interface illustrating an username selection screen 900 of an in-person verification meeting app that may be used in accordance with an illustrative embodiment. The username selection screen 900 includes a username entry field 905. In this embodiment, the username entry field 905 is automatically populated with the first part of the e-mail address entered in FIGS. 5 and 6 (the text before the @ symbol). However, the user may change their username from the automatically populated username. Further, a username should be unique, and therefore may have to be changed from just the first part of an e-mail.

FIG. 10 is a figure representing a user interface illustrating a payment information input screen 1000 of an in-person verification meeting app that may be used in accordance with an illustrative embodiment. The payment information input screen 1000 includes fields 1005 for entering credit card information. As discussed herein, other financial information may also be used such as bank account information for automatic debits and credits. In another example, a user may link their account in the app to a Paypal™ or other similar account using a button 1010. A user may be user will be able to skip entering their credit card or other payment information but may be prompted to enter their payment information upon creating or agreeing to a promise or meeting (as used herein, promise refers to an agreement to a meeting).

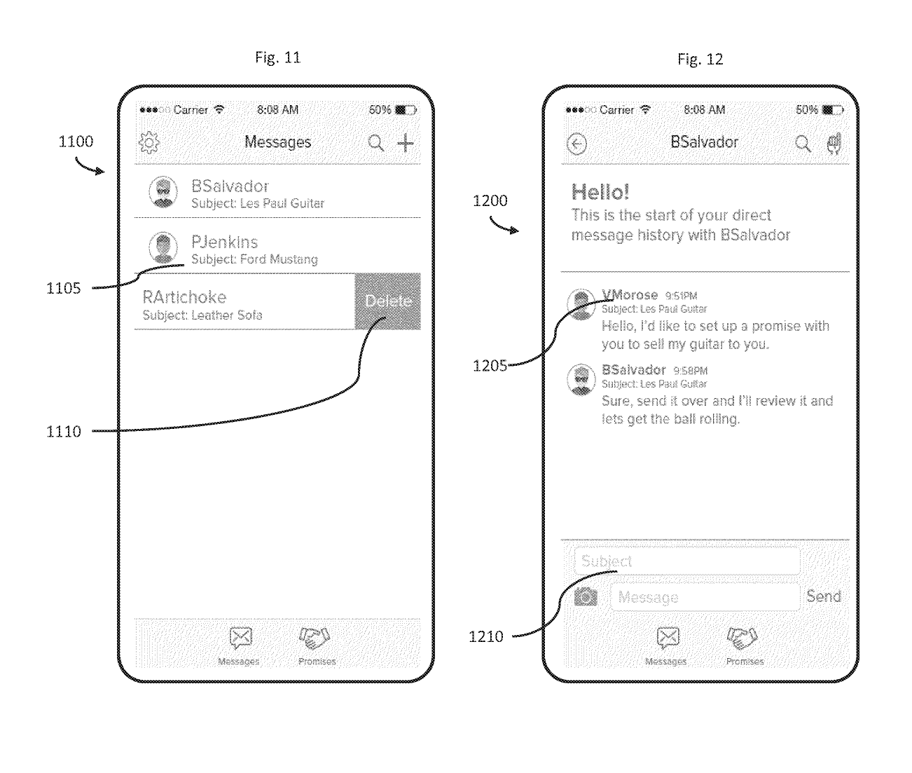

FIG. 11 is a figure representing a user interface illustrating a messages screen 1100 of an in-person verification meeting app that may be used in accordance with an illustrative embodiment. The messages screen 1100 includes message lines by author 1105 and option tabs 1110 (such as delete). The options tab may appear when a message lines by author 1105 is swiped to the left. The delete can then be selected to delete an entire conversation with a particular user.

FIG. 12 is a figure representing a user interface illustrating a conversation message screen 1200 of a personal data sharing app that may be used in accordance with an illustrative embodiment. The conversation message screen 1200 shows a conversation between the user of the device shown in FIG. 12 and a second user. Here, the conversation is with BSalvador, as also shown in the messages screen 1100 of FIG. 11. The conversation field 1205 shows the messages exchanged between the user and BSalvador. The conversation field 1205 shows both messages sent and messages received. The fields 1210 allow the user to write messages to BSalvador. Additionally, the user can indicate a subject of the messages, such as a product or service the user and BSalvador would like to exchange. The fields 1210 also include a camera icon that allows the user to, for example, take a picture of an item the user wants to sell to BSalvador so that BSalvador can see it better to decide whether they would like to have a meeting or not.

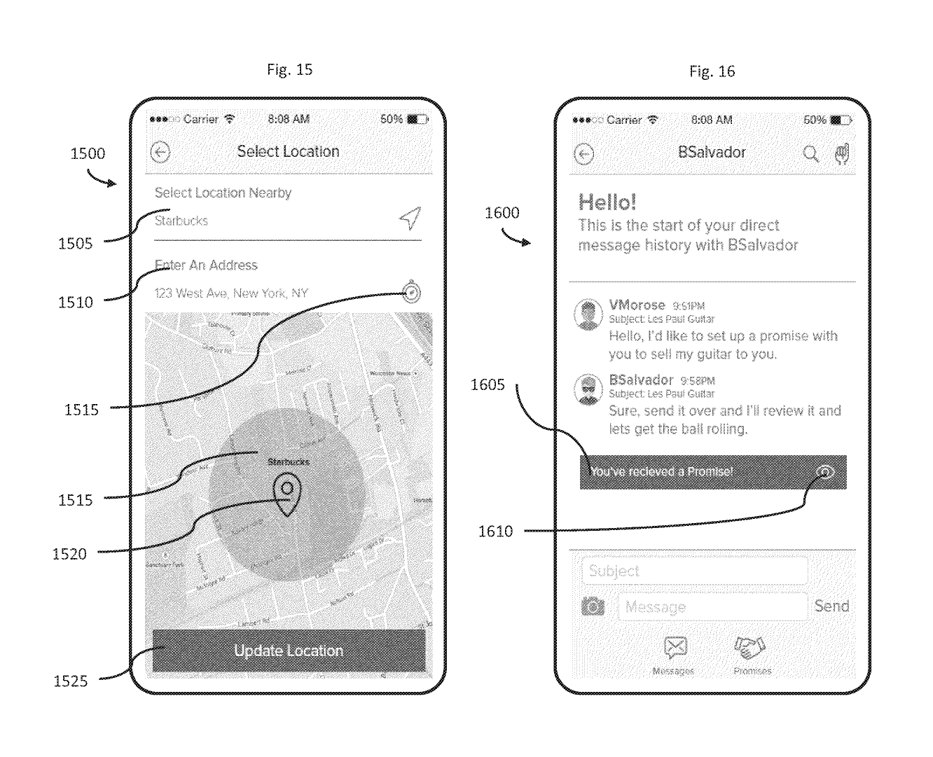

FIG. 13 is a figure representing a user interface illustrating a promise/meeting creation screen 1300 of an in-person verification meeting app that may be used in accordance with an illustrative embodiment. The promise/meeting creation screen 1300 shows an interface for selecting details for a meeting proposal/request. Field 1305 allows a user to specify a subject of the meeting proposal/request. Here the subject is an item that is subject to a possible exchange or sale at the meeting, a Gibson™ Les Paul™ Guitar. Field 1310 allows the user to select a proposed meeting time as disclosed herein. Field 1315 allows the user to select as part of the meeting time a date on which the proposed meeting should take place. Field 1320 allows the user to select a meeting location. Selecting the field 1320 may further lead to other interface screens as shown in FIGS. 14 and 15 to allow additional functionality for selecting the meeting location. Field 1325 allows the user to select an amount of money that will be transferred to a user if the other user is a no show for the meeting. Field 1330 allows the user to select cancelation terms for the meeting. Field 1335 allows the user to select the grace period threshold time around the meeting time (here plus/minus 15 minutes). Button 1340 when pressed sends the promise with the selected details. Some or all of the details in the promise/meeting creation screen 1300 may be auto-populated with defaults, such as the closest Starbucks™ or McDonalds™ as the location, a $5 no show amount, and 2 hour cancelation time. Other details may have limits. For example, a user may not be able to select a date more than one month away or may not be able to select a no-show amount for higher than $50.

FIG. 14 is a figure representing a user interface illustrating a location selection screen 1400 of an in-person verification meeting app that may be used in accordance with an illustrative embodiment. The location selection screen 1400 includes a search bar 1405. The user may type into the search bar 1405 for a place they are looking for, such as a Starbucks™ as shown in FIG. 14. Results 1410 may display similar places to what is typed into the search bar 1405. In another embodiment, the results 1410 may include sponsored locations or locations from an aggregator such as Yelp™. A user may select a location from the results 1410 as the meeting location for the meeting/promise request/proposal.

FIG. 15 is a figure representing a user interface illustrating a second location selection screen 1500 of an in-person verification meeting app that may be used in accordance with an illustrative embodiment. The second location selection screen 1500 shows another embodiment of how a meeting location may be selected for a meeting proposal/request. In one embodiment, the second location selection screen 1500 may be displayed after a meeting location is selected in from the results 1410 of FIG. 14. In such an embodiment, the map is displayed of the selected location so that the user can verify they have selected the correct location. In some embodiments, the user may be able to see their own location on the map to further verify the location they have selected.

In other embodiments, the second location selection screen 1500 may be displayed instead of the location selection screen 1400. The second location selection screen 1500 shows a selected meeting location 1520. The second location selection screen 1500 also shows a meeting location threshold distance 1515. The threshold distance 1515 can be used to show the users location to each other only when they are within the threshold distance 1515. In another embodiment, the threshold distance 1515 may show the area in which a user must be in at the meeting time in order to prevent a determination of a no show. A field 1505 allows a user to enter a search term to locate a place on the map. The system may automatically look for places similar to the search term that are close to the current location of the user. The second location selection screen 1500 also includes a field 1510 for entering an address to pinpoint on the map. As shown here, a Starbucks has been selected or pinpointed on the map. In another embodiment, the user may be able to move the map underneath the selected meeting location 1520 pin in order to locate the selected meeting location 1520 on the map manually. If the user selects the button 1525, the meeting location for a meeting request/proposal will be set at the location of the selected meeting location 1520 shown in the map. A button 1515 may also be pushed by the user, and the system may subsequently calculate the distance and/or travel time from the current location of the user to the selected meeting location 1520.

FIG. 16 is a figure representing a user interface illustrating a conversation message screen 1600 with a received proposed promise/meeting message in an in-person verification meeting app that may be used in accordance with an illustrative embodiment. The conversation message screen 1600 is similar to FIG. 12 except the conversation now shows an indication that the user has received a meeting/promise proposal/request at message 1605. The user may select button 1610 to view the details of the meeting/promise proposal/request.

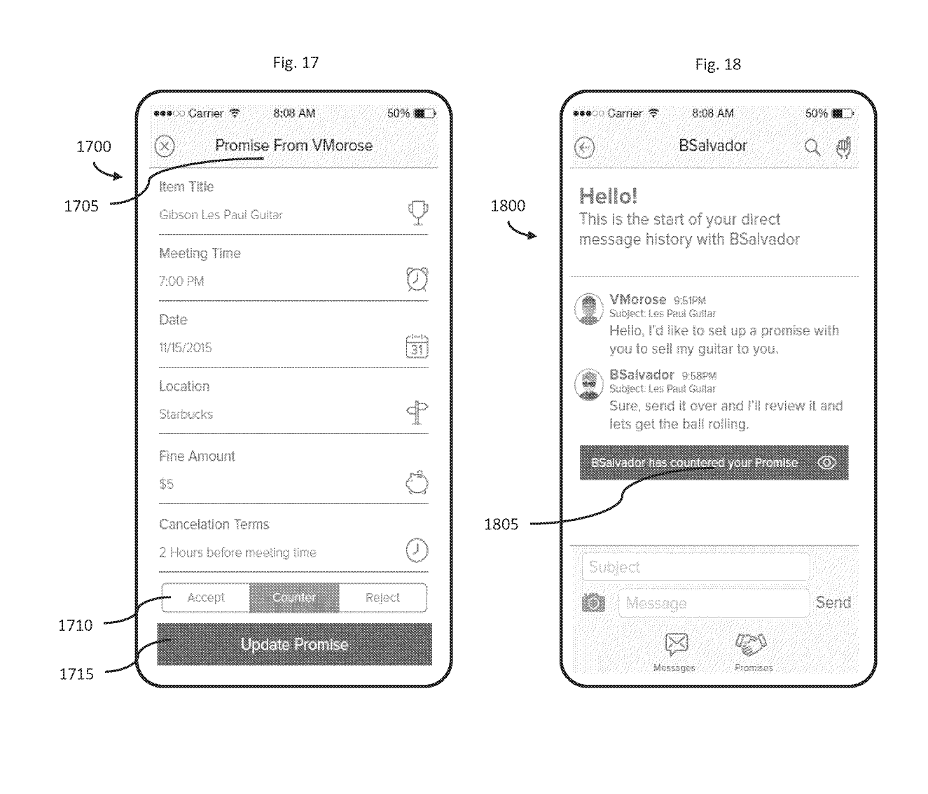

FIG. 17 is a figure representing a user interface illustrating a proposed promise/meeting screen 1700 of an in-person verification meeting app that may be used in accordance with an illustrative embodiment. If the button 1610 of FIG. 16 is selected, the system displays the proposed promise/meeting screen 1700. This screen identifies the details in the proposed promise/meeting. It includes an indication of who the proposed promise/meeting is from in a title 1705. It further includes selection buttons 1710. The buttons 1710 include accept, counter, and reject options. These options may be applied by a user similar to the method 300 discussed above with respect to FIG. 3. The user can select one of the options and select button 1715 to either accept, counter, or reject the proposed promise/meeting.

FIG. 18 is a figure representing a user interface illustrating a conversation message screen 1800 with a countered proposed promise/meeting message in an in-person verification meeting app that may be used in accordance with an illustrative embodiment. The conversation message screen 1800 is similar to FIGS. 12 and 16 except it shows a countered promise offer 1805. Accordingly, a user can easily see the status of a meeting proposal/request by going to a conversation with another user. In each of FIGS. 12, 16, and 18, users may message each other and send meeting proposal/requests. Such communication may be accomplished without the use of personal information such as phone numbers and/or e-mail addresses being known to the users. In other words, users can message each other through the app with relative privacy protection.

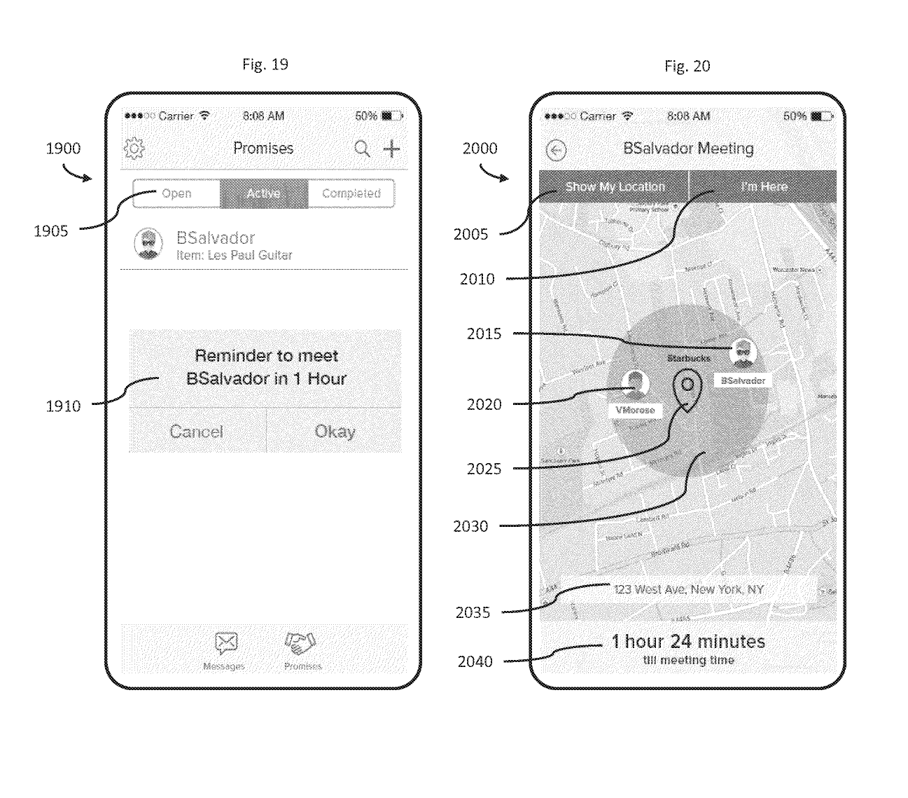

FIG. 19 is a figure representing a user interface illustrating a promise/meeting screen 1900 with a reminder dialog in an in-person verification meeting app that may be used in accordance with an illustrative embodiment. The promise/meeting screen 1900 shows a push notification 1910 that reminds a user about a meeting. The user may be given the chance to cancel the meeting. The system may automatically send the push notification 1910 at a certain amount of time or times before a cancelation time ends so that a user has time to cancel a meeting if needed. Push notifications may also be displayed outside of the app itself in order to provide reminders to the user. The system may also send notifications after the cancelation time ends so that the user is still reminded to actually attend the meeting to prevent a determination of a no show. The promise/meeting screen 1900 further includes promise/meeting sorter buttons 1905. The promises/meetings can be sorted with the buttons 1905 to show open (not sent to another user and/or not yet assented to by two users), active (assented to by both users but meeting has not yet occurred), and completed (assented to by both users and meeting has already occurred).

FIG. 20 is a figure representing a user interface illustrating an active promise map screen 2000 of an in-person verification meeting app that may be used in accordance with an illustrative embodiment. The active promise map screen 2000 shows a detail of an active promise/meeting where both users have assented to the details of a meeting but the meeting has not occurred yet. The active promise map screen 2000 includes a show my location button 2005. If a user's location is showing on the map, button 2005 can be selected to hide the user's location. The button 2005 can be selected at any time by a first user to show/hide the location of the first user to a second user to a similar map displayed on the second user's device. In an alternative embodiment, the show my location button 2005 may only show the first user's location when they are within a threshold distance 2030 of a meeting location 2025. In another embodiment, the first user's location may automatically be shown to the second user when the first user device enters within the threshold distance 2030, and optionally the first user may show their location to the second user outside the threshold distance 2030 by selecting the button 2005.

An I'm here button 2010 sends a message or alert from a first user to a second user that the first user has arrived at or near the meeting location 2025. This may be helpful if, for example, the second user has free time and would like to stop by early (before the meeting time) to conduct the meeting. This may also be helpful if they second user is waiting for the meeting at the meeting location but is not checking their device. By sending the message or alert, the second user will know to look for the first user, perhaps even using the active promise map screen 2000. The active promise map screen 2000 also shows a first user 2015 and a second user 202 within the threshold distance 2030. The active promise map screen 2000 also shows an address associated with the meeting location 2025 and a countdown clock 2040 indicating how long until the meeting time (i.e., how long a user has to meet the promise/meeting request details). In sum, the active promise map screen 2000 shows an active promise map view that shows the meeting location with a, for example, 100 foot radius around the meeting location that shows the two users if they are within the radius.

FIG. 21 is a figure representing a user interface illustrating a currently present screen 2100 of an in-person verification meeting app that may be used in accordance with an illustrative embodiment. The currently present screen 2100 shows who has arrived for a meeting. In this embodiment, the present list 2105 shows that two users are here. Although it is contemplated that the systems and methods disclosed herein can accommodate two or more users for one meeting, in this embodiment only two users are attending the meeting. Accordingly, since both users are present early, the users can manually choose to start meeting now by selecting a button 2110. This allows the users to conduct the meeting and prevent a no show determination at the meeting time regardless of the location of the user devices at the meeting time. A user that has been determined to be no show is sent a push notification or other alert indicating they were a no show and any charge that has been assessed as a result of the no show. Similarly, the user that did meet the promise condition can also be sent a push notification or other alert that the other user broke the meeting/promise details, and that a monetary amount will be credited to the user's account. Additionally, the user who was not considered a no show has veto power to override the no show and reverse the determination of the no show.

FIG. 22 is a figure representing a user interface illustrating a search screen 2200 of an in-person verification meeting app that may be used in accordance with an illustrative embodiment. The search screen 2200 shows a search field 2205 where a user can search for other users to message or propose meetings to. The results 2210 show search results. A user can enter a username and/or email address to search for another user within the app. A user may also be able to select another user.

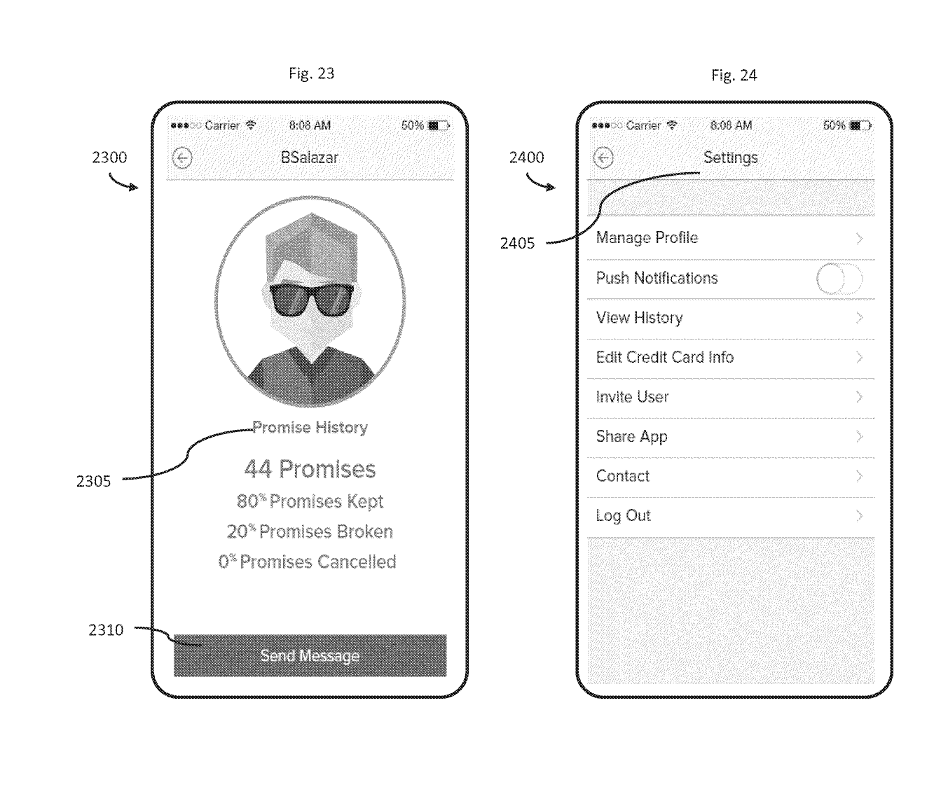

FIG. 23 is a figure representing a user interface illustrating a search result profile screen 2300 of an in-person verification meeting app that may be used in accordance with an illustrative embodiment. The selection of a user from the search screen 2200 can yield the search result profile screen 2300. The search result profile screen 2300 shows promise/meeting history 2305 of the user and allows selection of button 2310 to message the user.

FIG. 24 is a figure representing a user interface illustrating a settings screen 2400 of an in-person verification meeting app that may be used in accordance with an illustrative embodiment. The settings screen 2400 allows a user to adjust their profile settings 2405, whether push notifications are on or not, view the user's history, edit credit card or other financial account information, invite others to use the app, share the app with others, contact support for the app, and/or log out.

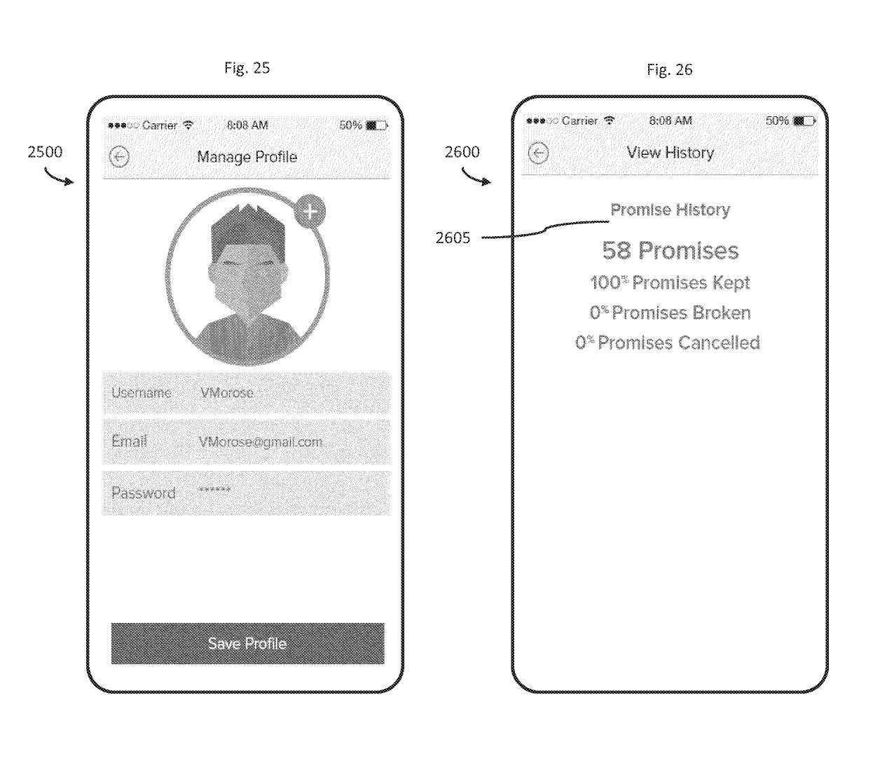

FIG. 25 is a figure representing a user interface illustrating a manage profile screen 2500 of an in-person verification meeting app that may be used in accordance with an illustrative embodiment. The manage profile screen 2500 allows a user to change their username, picture, e-mail address, and/or password.

FIG. 26 is a figure representing a user interface illustrating a profile history screen 2600 of an in-person verification meeting app that may be used in accordance with an illustrative embodiment. The profile history screen 2600 allows a user to see their own history with respect to promises/meetings kept, broken, and canceled.

Other various embodiments and applications of the systems and methods in this disclosure are contemplated herein. For example, the systems and methods may be used give out discounts at retailers, restaurants, etc. For example, a retailer or restaurant may want more customers to shop or eat there during a certain time of day when business is slow. The business may send out a meeting request to users to come to the store or restaurant at a certain time or range of times in order to get a discount at the store or restaurant. If the system determines a no show by the user, the user will not get the discount.

The systems and methods disclosed herein may also be implemented in a scavenger hunt type game. For example, a scavenger hunt may be organized where users must go to certain locations at or within certain times. The system disclosed herein can be used to determine whether users are successful or not. In other words, a no show determination for a particular stop on a scavenger would indicate that a user did not complete that step of the scavenger hunt.

The payment and/or financial account information entered by users may also be used to facilitate transactions between users. For example, when two users meet to potentially exchange a television, if the users agree on a price for the television, the users may use the in-person meeting verification app to assent to a sale price for the television, which can then be charged automatically to the already entered payment and/or financial account information of the user buying the television, and can be credited or deposited into an account or payment medium of the selling user. The in-person meeting verification app may also suggest meeting locations based on user suggestions, safety ratings, or sponsored locations. Users can also be charged for the service of using the app. For example, users may be charged a fee on transactions executed with the app. In another example, one or all users related to a meeting may be charged a fee each time a proposed meeting has been accepted/assented to.

The systems and methods disclosed herein advantageously provide significant improvements to the functioning of a computer, server, or other similar device. For example, the systems and methods disclosed herein provide more efficient in-person meeting capabilities. By utilizing the more efficient ways of matching users for in-person meetings as disclosed herein, the computers, servers, and/or other similar devices that are used for online marketplaces, e-mailing, posting, messaging, etc., will operate more efficiently. For example, when a user posts on an online marketplace a product or service for sale, a failed in-person meeting can lead to more posting, e-mailing, messaging, etc. that may cause extra traffic and congestion for servers, processors, and other devices used by the user, the online marketplaces, and everywhere in between. Thus, resources used to facilitate failed in-person meetings have gone to waste. That is, a computing device is not performing efficiently when it performs tasks that must be repeated when an in-person meeting fails. With the size of online marketplaces, failed in-person meetings can cause a huge amount of increased traffic and congestion on these sites, whereas if more in-person meetings succeeded with the use of the systems and methods disclosed herein, traffic and congestion could be drastically reduce improving the hardware functioning that the online marketplaces are implemented on. Thus, the methods and systems disclosed herein provide a significantly cost and performance savings for both marketplaces' and users' devices, servers, and any other computing devices and transmission channels used to facilitate in-person meetings.

In addition, when more users are reposting failed listings and carrying out communications to facilitate in-person meetings for those previously failed listings, it can reduce overall bandwidth of e-mail systems, messaging systems, and online marketplace servers and processors. That is, each time the systems and methods disclosed herein facilitate a successful in-person meeting, it actually prevents further traffic in the future. Thus, the successful in-person meetings will cause various systems to have lower traffic and more available bandwidth in the future. Such functionality helps improve the overall system, as well as both user experience.

The systems and methods disclosed herein also make in-person meetings much easier. The systems and methods disclosed herein help users communicate as they are meeting or about to meet, lowering the possibility of accidentally missing each other despite both showing up to the correct location at the correct time. To do so, the systems and methods disclosed herein offer technical solutions to technical and internet centric problems. For example, if users connect via an online marketplace, they can be very physically remote from each other and extremely unfamiliar with each other (e.g., complete strangers). These types of online marketplaces create difficulties in successfully meeting up and avoiding the loss of time and effort that happens when one party is a no show. Accordingly, the systems and methods disclosed herein address this technical and internet centric problem with a technical and internet centric solution: allowing users to both assent to meeting details before a meeting, automatically determining using location determination software and hardware on user devices and elsewhere to determine no shows, and applying penalties for users that no show. Such disincentives to no shows can drastically reduce the number of no shows and accidental misses when users of an online marketplace attempt to meet, despite being unfamiliar with each other and possibly very physically remote from each other.

Additionally, the systems and methods disclosed herein are worthwhile for the particular way in which the no shows are determined. By determining no shows automatically and assessing charges automatically, a user does not need to worry about another user that no shows, as the system will automatically determine the no show using location determination technology and will automatically assess a penalty charge. Advantageously, these factors add to the usefulness of the systems and methods disclosed herein. However, the systems and methods disclosed herein do not foreclose all methods of in-person meetings, but rather supplements them in a particular way that makes in-person meetings better than in-person meetings that as they are currently organized and practiced.

In an illustrative embodiment, the operations described herein can be implemented at least in part as computer-readable instructions stored on a computer-readable medium or memory. Upon execution of the computer-readable instructions by a processor, the computer-readable instructions can cause a computing device to perform the operations.

The foregoing description of illustrative embodiments has been presented for purposes of illustration and of description. It is not intended to be exhaustive or limiting with respect to the precise form disclosed, and modifications and variations are possible in light of the above teachings or may be acquired from practice of the disclosed embodiments. It is intended that the scope of the invention be defined by the claims appended hereto and their equivalents.

1. A method comprising:
receiving, by a processor of a computing device, a first indication of assent to a meeting from a first user device wherein the meeting comprises a meeting time and a meeting location;
receiving, by the processor, a second indication of assent to the meeting from a second user device; p1 determining, by the processor, first user device geo-coordinates and second device geo-coordinates at least within a threshold time of the meeting;
determining, by the processor, based on the first user device geo-coordinates and the second user device geo-coordinates, a no show indicating that at least one of the first user device and the second user device is not within a threshold distance of the meeting location within the threshold time of the meeting time by:
comparing at least one of the first user device geo-coordinates and the second user device geo-coordinates to a meeting location geo-coordinates, and
determining that the first user device geo-coordinates are not within the threshold distance of the meeting location geo-coordinates: and
assessing, by the processor, based on the determination of the no show, at least one of:
a punitive measure to an account associated with the first user device and
a positive measure to an account associated with the second user device.

2. The method of claim 1, wherein the determination of the no show is automatically made without regard to any inputs from a first user into a user interface of the first user device and further without regard to any inputs from a second user into a user interface of the second user device.

3-5. (canceled)

6. The method of claim 1, wherein the no show is determined based on a determination that only one, but not both, of the first user device geo-coordinates and the second user device geo-coordinates are not within the threshold distance of the meeting location geo-coordinates within the threshold time of the meeting time.

7. The method of claim 1, further comprising receiving, by the processor, an indication of a cancellation time from the first user device, wherein the cancellation time comprises an amount of time before the meeting time within which an indication of revoked assent to the meeting must be received from the first user device or the second user device to prevent a determination of a no show.

8. An apparatus comprising:
a memory;
a processor operatively coupled to the memory; and
a first set of instructions stored on the memory and configured to be executed by the processor to cause the processor to:
receive a first indication of assent to a meeting from a first user device, wherein the meeting comprises a meeting time and a meeting location;
receive a second indication of assent to the meeting from a second user device;
determine, first user device geo-coordinates and second device geo-coordinates at least within a threshold time of the meeting;
determine, based on the first user device geo-coordinates and the second user device geo-coordinates, a no show indicating that at least one of the first user device and the second user device is not within a threshold distance of the meeting location within the threshold time of the meeting time, wherein the determination of the no show comprises:
a comparison of at least one of the first user device geo-coordinates and the second user device geo-coordinates to a meeting location geo-coordinates, and
a determination based on the comparison that the first user device geo-coordinates are not within the threshold distance of the meeting location geo-coordinates; and
assess, based on the determination of the no show, at least one of:
a punitive measure to an account associated with the first user device and
a positive measure to an account associated with the second user device.

9. The apparatus of claim 8, wherein the first user device geo-coordinates are determined by a first global positioning system (GPS) locator in the first user device and the first user device geo-coordinates are received by the processor of a server over a communications network.

10. The apparatus of claim 8, wherein the first user device geo-coordinates are determined by a first near field communication (NFC) device in the first user device that is configured to communicate with other NFC devices, wherein the first user device geo-coordinates are inferred by the processor of a server based on a first communication between the first NFC device and one of the other NFC devices based on an indication of the first communication that is received by the processor of the server over a communications network.

11. The apparatus of claim 8, wherein the first user device geo-coordinates are determined by a first wireless transponder device of the first user device that is configured to communicate wirelessly with a plurality of network devices, wherein the first user device geo-coordinates are inferred by the processor of a server based on a first communication between the first wireless transponder device and one of the plurality of network devices based on an indication of the first communication that is received by the processor of the server over a communications network.

12. The apparatus of claim 8, wherein the meeting time is a range of time lasting from a first time to a second time.

13. The apparatus of claim 12, wherein the threshold time for the meeting is zero minutes, such that the no show is determined when one of the first user device geo-coordinates and the second user device geo-coordinates are not within the threshold distance of the meeting location geo-coordinates at any of the range of time.

14. The apparatus of claim 8, wherein the meeting time is a specific time, and the threshold time is an amount of time, such that the no show is determined when the first user device geo-coordinates and the second user device geo-coordinates are not within the threshold distance of the meeting location geo-coordinates at any time within the amount of time before the specific time to the amount of time after the specific time.

15. A non-transitory computer readable medium having instructions stored thereon that, upon execution by a computing device, cause the computing device to perform operations, wherein the instructions comprise:
instructions to receive a first indication of assent to a meeting from a first user device the meeting comprises a meeting time and a meeting location;
instructions to receive a second indication of assent to the meeting from a second user device;
instructions to determine, first user device geo-coordinates and second device geo-coordinates at least within a threshold time of the meeting;
instructions to determine, based on the first user device geo-coordinates and the second user device geo-coordinates, a no show indicating that at least one of the first user device and the second user device is not within a threshold distance of the meeting location within the threshold time of the meeting time, wherein the determination of the no show comprises:
a comparison of at least one of the first user device geo-coordinates and the second user device geo-coordinates to a meeting location geo-coordinates, and
a determination based on the comparison that the first user device geo-coordinates are not within the threshold distance of the meeting location geo-coordinates: and
instructions to assess, based on the determination of the no show, at least one of:
a punitive measure to an account associated with the first user device and
a positive measure to an account associated with the second user device.

16. The non-transitory computer readable medium of claim 15, wherein the meeting is related to a sale of a good or provision of a service.

17. The non-transitory computer readable medium of claim 16, wherein the sale of the good or the provision of the service is related to an online posting.

18. The non-transitory computer readable medium of claim 17, wherein the instructions further comprise:
instructions to receive an indication from the first user device or the second user device that the sale of the good or the provision of the service is completed at the meeting; and
instructions to remove the online posting from a forum in which the online posting is published.

19. The non-transitory computer readable medium of claim 17, wherein the instructions further comprise:
instructions to receive an indication from the first user device or the second user device that the sale of the good or the provision of the service is completed at the meeting; and
instructions to re-publish the online posting in a forum in which the online posting was previously published.

20. The non-transitory computer readable medium of claim 16, wherein the sale of the good or the provision of the service is related to a plurality of meeting requests received or initiated by a user of the first user device, and wherein instructions further comprise:
instructions to cancel or revoke the plurality of meeting requests based on the second indication of assent to the meeting from the second user device.
